(19) United States
(12) Patent Application Publication
(10) Pub. No.: US 2014/0366140 A1
(43) Pub. Date: Dec. 11, 2014

(54) ESTIMATING A QUANTITY OF EXPLOITABLE SECURITY VULNERABILITIES IN A RELEASE OF AN APPLICATION

(71) Applicant: Hewlett-Packard Development Company, L.P., Houston, TX (US)

(72) Inventors: Liqun CHEN, Bristol (GB); Nigel EDWARDS, Bristol (GB)

(21) Appl. No.: 13/914,355

(22) Filed: Jun. 10, 2013

(51) Int. Cl. G06F 21/57

(52) U.S. Cl. CPC G06F 21/577
USPC 726/25

(57) ABSTRACT

Examples disclosed herein relate to estimating a quantity of exploitable security vulnerabilities in a release of an application. Examples include acquiring a source code analysis result representing a number of source code issues identified by source code analysis in a target release of an application. Examples further include estimating a quantity of exploitable security vulnerabilities contained in the target release of the application based on the source code analysis result and metrics for a plurality of historic releases of the application.

### BACKGROUND

When released, a computer application may contain a number of exploitable security vulnerabilities that may render a computer system executing the application susceptible to being compromised. Generally, the entity that developed the application may endeavor to remedy such exploitable security vulnerabilities when they are discovered. However, it is difficult to ensure that a release of an application contains no exploitable security vulnerabilities.

### BRIEF DESCRIPTION OF THE DRAWINGS

The following detailed description references the drawings, wherein:

FIG. 1A is a block diagram of an example system to estimate a quantity of exploitable security vulnerabilities contained in a target release of an application;

FIG. 1B is a table illustrating an example of metrics for a plurality of historic releases of an application;

FIG. 1C illustrates a graph of an example regression function relating example metrics of the table of FIG. 1B;

FIG. 2 is a block diagram of an example system to estimate a quantity of exploitable security vulnerabilities contained in a target release of an application based on information stored in a historic data repository;

FIG. 3 is a block diagram of an example computing device to estimate a quantity of exploitable security vulnerabilities contained in a target release of an application based on source code analysis results and quantitative security vulnerability reporting metrics;

FIG. 4 is a flowchart of an example method for estimating a quantity of exploitable security vulnerabilities contained in a target release of an application based on a source code analysis result and predictive information; and

FIG. 5 is a flowchart of an example method for calculating an estimate of the strength of a correlation between exploitable security vulnerability reporting rates and source code analysis metrics.

### DETAILED DESCRIPTION

Since it may be difficult to ensure theta release of an application contains no exploitable security vulnerabilities, an application may contain a number of undiscovered vulnerabilities upon its release. The presence of such undiscovered vulnerabilities in an application presents a risk for users of the application. As such, it may be beneficial to predict the number of exploitable security vulnerabilities that an application contains upon its release so that potential users of the application may assess how great of a risk the application presents. As used herein, an “exploitable security vulnerability” of an application is a property, function, or other aspect of the application that may be leveraged to compromise any aspect of the security of a system executing the application. Examples of exploitable security vulnerabilities include buffer overflows, cross-site scripting errors, errors opening an application to a structured query language (SQL) injection, etc.

When an exploitable security vulnerability is discovered in an application, it may be reported publicly. In this manner, users of the application may be notified of the vulnerability, and the application developer may take steps to fix the vulnerability. Information regarding such reported vulnerabilities may be collected in a common repository, where each reported vulnerability may be associated with the application release in which it was discovered. Such a repository may thus indicate the exploitable vulnerabilities reported for various releases of an application. As an example, the Common Vulnerabilities and Exposures dictionary (CVE) may indicate the exploitable security vulnerabilities publicly reported for each of various different applications, and for various releases (e.g., versions) of those applications.

However, such a repository does not contain information about undiscovered exploitable security vulnerabilities in a new release of an application. In some cases, an attempt may be made to predict the amount of undiscovered exploitable security vulnerabilities present in the new release based on the respective numbers of vulnerabilities reported for previous releases of the application. While accounting for historical trends, this method of prediction does not take into account any analysis of the new release itself, and instead relies exclusively on information about the prior releases. However, changes in a new release relative to prior release(s) may confound vulnerability reporting trends that may be inferred from information about prior releases. For example, a new release may introduce problems not present in prior release(s), or may eliminate problems present in prior release(s). As such, predicting vulnerabilities for a new release based exclusively on information for prior releases may produce inaccurate results.

To address these issues, examples described herein may determine an estimate of a quantity of exploitable security vulnerabilities contained in a target release of an application based on reported exploitable security vulnerabilities for prior releases of the application and a result of source code analysis performed on the target release. Examples described herein may acquire a source code analysis result representing a number of source code issues in a target release of an application, as identified by a source code analysis system. Examples may also acquire predictive information at least partially representing a predictive function relating a plurality of quantitative security vulnerability reporting metrics for a plurality of historic releases of the application to a plurality of quantitative source code analysis metrics for the historic releases. Examples may further determine an estimate of a quantity of exploitable security vulnerabilities contained in the target release of the application based on the source code analysis result for the target release and the predictive information for the historic releases.

In this manner, examples described herein may take into account the source code of the new release itself in addition to information about prior releases of the application. As such, examples described herein may provide a more reliable estimate of the quantity of exploitable security vulnerabilities contained in the target release, and thus a more reliable estimate of the risk of using the target release. In some examples, a user may consider the estimate of the quantity of exploitable security vulnerabilities contained in the target release of the application when deciding whether to upgrade to the target release or continue use of a historic release of the application.

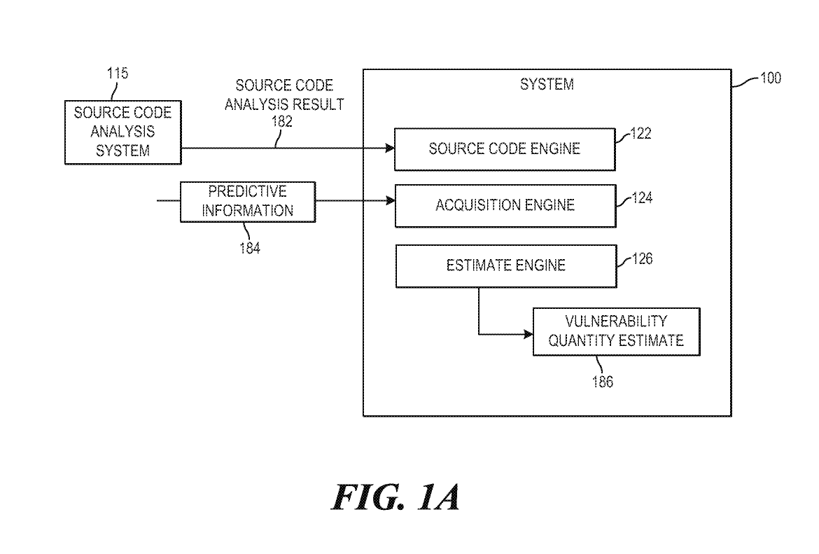

Referring now to the drawings. FIG. 1A is a block diagram of an example system 100 to estimate a quantity of exploitable security vulnerabilities contained in a target release of an application. As used herein, an “application” (or “computer application”) is a collection of machine-readable instructions that are executable by a processing resource. In some examples, an application may be embodied in any of a plurality of different forms. For example, the application may be embodied in source code, in executable(s) derived (e.g., compiled) from the source code, etc. As used herein, a “release” of an application is a version or other instance of an application.

In the example of FIG. 1A, system 100 includes engines 122, 124, and 126. In some examples, system 100 may include additional engine(s). System 100 may be implemented by one or more computing devices. As used herein, a “computing device” may be a server, computer networking device, chip set, desktop computer, notebook computer, workstation, or any other processing device or equipment. A computing device at least partially implementing system 100 may include at least one processing resource. In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof.

Each of engines 122, 124, 126, and any other engines of system 100, may be any combination of hardware and programming to implement the functionalities of the respective engine. Such combinations of hardware and programming may be implemented in a number of different ways. For example, the programming may be processor executable instructions stored on a non-transitory machine-readable storage medium and the hardware may include a processing resource to execute those instructions. In such examples, the machine-readable storage medium may store instructions that, when executed by the processing resource, implement the engines of system 100. The machine-readable storage medium storing the instructions may be integrated in the same computing device as the processing resource to execute the instructions, or the machine-readable storage medium may be separate from but accessible to the computing device and the processing resource. The processing resource may comprise one processor or multiple processors included in a single computing device or distributed across multiple computing devices.

In some examples, the instructions can be part of an installation package that, when installed, can be executed by the processing resource to implement the engines of system 100. In such examples, the machine-readable storage medium may be a portable medium, such as a compact disc. DVD, or flash drive, or a memory maintained by a server from which the installation package can be downloaded and installed. In other examples, the instructions may be part of an application or applications already installed on a computing device including the processing resource. In such examples, the machine-readable storage medium may include memory such as a hard drive, solid state drive, or the like.

As used herein, a “machine-readable storage medium” may be any electronic, magnetic, optical, or other physical storage apparatus to contain or store information such as executable instructions, data, and the like. For example, any machine-readable storage medium described herein may be any of a storage drive (e.g., a hard drive), flash memory, Random Access Memory (RAM), any type of storage disc (e.g., a compact disc, a DVD, etc.), and the like, or a combination thereof. Further, any machine-readable storage medium described herein may be non-transitory.

In the example of FIG. 1A, system 100 is in communication with a source code analysis system 115 capable of performing source code analysis. As used herein, “source code analysis” is an automated process to examine a collection of source code to identify source code issues in the source code. Examples of source code analysis include static source code analysis, in which the source code is examined without any execution of the source code, and dynamic source code analysis, which involves at least some execution of the code and may utilize test data. Any system capable of performing source code analysis may be referred to herein as a “source code analysis system”. As used herein, a “source code issue” (or “issue” herein) is any feature, attribute, property, or other characteristic of a collection of source code that is identified by a source code analysis system as a potential problem (e.g., a potential security vulnerability, defect, bug, etc.), an undesirable characteristic of the source code, or a combination thereof.

Source code analysis system 115 may perform source code analysis on a target release of an application to generate source code analysis result(s) 182. Source code engine 122 may actively or passively acquire (e.g., retrieve, receive, etc.) source code analysis result 182 from source code analysis system 115. In such examples, result 182 may represent a number of source code issues identified by source code analysis system 115 in the target release of the application.

As used herein, a target release of an application may be a release (or version) of an application for which an estimate of a quantity of exploitable security vulnerabilities is to be determined (e.g., by system 100). In some examples, engine 122 may provide source code of the target release to system 115 for source code analysis. In other examples, engine 122 may provide system 115 an address, link, or other information that system 115 may use to retrieve source code of the target release. As used herein, a “source code analysis result” is information representing a number of source code issues identified in source code of a particular release of an application by source code analysis performed on the particular release. For example, a source code analysis result may indicate a total a number of source code issues identified in a release of an application, or some portion thereof.

In some examples, source code analysis results may be obtained for prior releases of the application that predate the target release. Such prior releases of an application may be referred to herein as “historic releases” of the application. Source code analysis results for historic release(s) (which may be referred to herein as “historic source code analysis results”) may be obtained from system 115, or any other system that performs source code analysis. The historic source code analysis results may be stored in a historic data repository (e.g., a database, etc.) that is included in or separate from system 100.

Quantitative source code analysis metrics for the historic releases of the application may be obtained based on the historic source code analysis results. As used herein, a quantitative source code analysis metric is a measure representing a quantity of source code analysis issues identified in a respective historic release of an application. An example of a quantitative source code analysis metric is an issue density value for a release of an application. As used herein, an “issue density value” is a measure of the number of issues represented by a source code analysis result for a release of an application relative to the size of the release of the application. For example, an issue density value for a release of an application may be derived by dividing a source code analysis result (e.g., a number of issues identified) for a release of an application by the number of lines of source code in the release.

Features of system 100 are described below in relation to FIGS. 1B-1C in the context of an example in which a plurality of historic releases 1-10 of an application that predate the target release of the application. FIG. 1B is a table 140 illustrating an example of metrics for the plurality of historic releases for the application. In table 140, column 140A shows respective release (or version) numbers for the historic releases, column 140B shows release dates for the respective releases, column 140C shows the number of lines of source code in the respective historic releases, and column 140D shows example quantitative source code analysis metrics. In the example of FIG. 1B, the quantitative source code analysis metrics shown in column 140D are respective issue density values for the historic releases. The issue density values of column 140D each represent, for each historic release, the total number of source code analysis issues identified for the release divided by the number of lines of code of the release.

Column 140E shows example quantitative security vulnerability reporting metrics for the historic releases. In examples described herein, a quantitative security vulnerability reporting metric for a release of an application is a measure representing a quantity of exploitable security vulnerabilities reported for the release of the application. In some examples, a quantitative security vulnerability reporting metric for a release may be a value derived from information regarding reported exploitable security vulnerabilities for the release. Such information may be obtained (directly or indirectly) from the CVE (described above), or any other publicly accessible source of such information. In other examples, such information may be obtained from a non-public data source, such as a non-public repository of exploitable security vulnerabilities maintained by a developer for a proprietary application, for example.

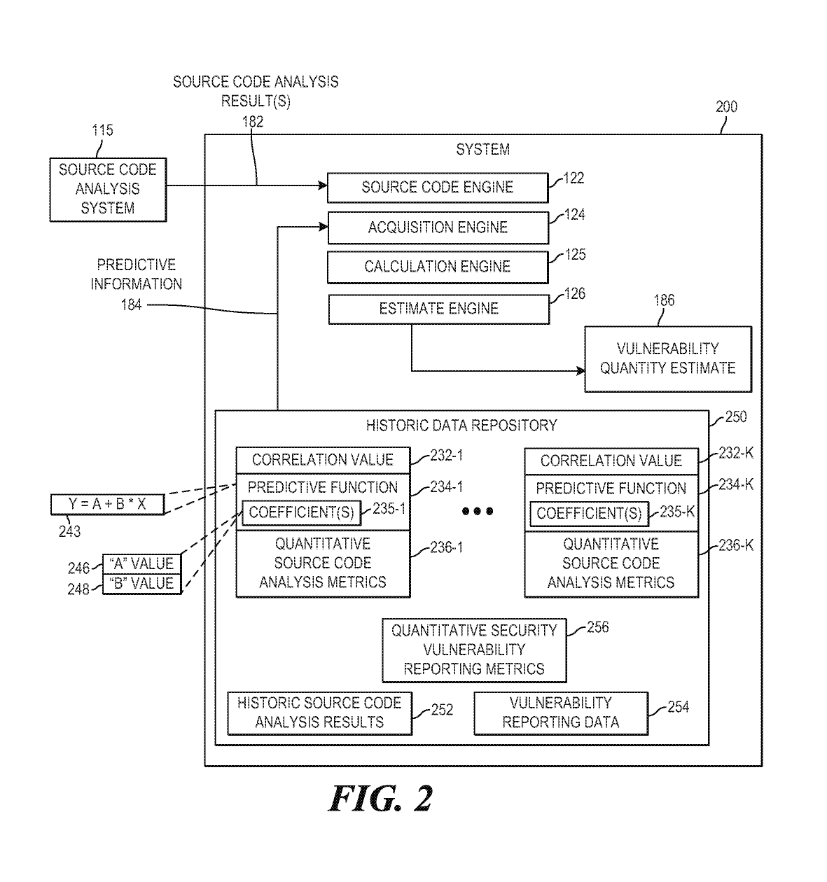

In the example of FIG. 1B, the quantitative security vulnerability reporting metrics for the historic releases (shown in column 140E) are respective exploitable security vulnerability reporting rates. In examples described herein, an exploitable security vulnerability reporting rate for a release of an application is a measure of the number of exploitable security vulnerabilities reported for the release per year (or any other length of time). The values in column 140E each represent a measure of the number of exploitable security vulnerabilities reported per year in a respective one of the historic release. The values in column 140E may be calculated as described below in relation to FIG. 3. Although table 140 is shown herein for illustrative purposes, the information shown therein may be stored (e.g., in the historic data repository) in any suitable form or format. Additionally, some of the data shown therein may be omitted from such storage.

In some examples, a predictive function relating the quantitative security vulnerability reporting metrics for the historic releases to the quantitative source code analysis metrics for the historic releases may be determined. As used herein, a predictive function may be a function that at least approximates a relationship between a set of first values and a set of second values. Such a function may be used to predict a new first value (i.e., not contained in the data set used to generate the predictive function) based on new second value (i.e., not contained in the data set used to generate the predictive function), and vice versa. The predictive function may be a regression function, such as a linear or non-linear regression function, or any other suitable function.

FIG. 1C illustrates a graph 141 of an example regression function 143 relating example metrics of table 140 of FIG. 1B. In the example of FIGS. 1B and 1C, the quantitative source code analysis metrics (i.e., the issue density values) of column 140D for the historic releases are treated as respective values for the variable “X” (i.e., “X” values), and the quantitative security vulnerability reporting metrics (i.e., the reporting rates) of column 140E for each historic release are treated as respective values for the variable “Y” (i.e., “Y” values). To illustrate, an (X, Y) value pair for each of historic releases 1-10 is shown as a respective point on graph 141.

In some examples, a predictive function relating these X and Y values may be determined. In the example of FIG. 1C, a linear regression function 143 may be generated based on the X and Y values of table 140 for the historic releases. The regression function may have a form of Y=A+B*X, where A and B are coefficients of the regression function. The regression function may be determined (e.g., calculated, etc.) in any suitable manner. In the example of FIG. 1C, the regression function 143 determined based on the X and Y values of table 140 is Y=0.5811+0.4731*X, which is illustrated by line 149 in graph 141. Although graph 141 is shown for illustrative purposes, the function and values described in relation to FIG. 1C may be determined without generating or using any graph.

In the example of FIG. 1C, the value of the A coefficient 146 of function 143 is 0.5811, and the value of the B coefficient 148 of function 143 is 0.7431. In some examples, a coefficient of determination (CD) 144 (also known as R²) for linear regression function 143 may be determined in any suitable manner. The CD value 144 may be an estimate of the strength of the correlation between the X and Y values. CD value 144 may be a value between 0 and 1, where the closer the value is to 1, the stronger the correlation. In the example of FIG. 1C, CD 144 for regression 143 is 0.8749, indicating a relatively strong correlation. In some examples, a correlation coefficient (CC) 145 (also known as the Pearson product-moment correlation coefficient, or R) for linear regression function 143 may be determined in any suitable manner (e.g., taking the square root of CD value 144). The CC value 145 may be another estimate of the strength of the correlation between the X and Y values, represented as a value between 0 and 1, where the closer the value is to 1, the stronger the correlation. In the example of FIG. 1C, CC 145 for regression 143 is 0.9353, indicating a relatively strong correlation. The information determined and illustrated in FIGS. 1B and 1C, or a portion thereof, may be stored in the historic data repository, which may be included in or separate from system 100 of FIG. 1A, as described above.

Referring again to FIG. 1A, acquisition engine 124 may acquire predictive information 184 at least partially representing a predictive function relating a plurality of quantitative security vulnerability reporting metrics for historic releases of the application (predating the target release) to a plurality of quantitative source code analysis metrics for the historic releases. As used herein, predictive information may be any information suitable to represent a predictive function. For example, predictive information 184 may include any of the full predictive function in any suitable form, information from which the full predictive function may be derived (e.g., coefficient(s) of the function), an indication of the type of function (e.g., linear regression, etc.), or a combination thereof. In some examples, instructions 124 may acquire predictive information 184 from a database or other repository included in or separate from system 100. For example, predictive information 184 may be stored in the above-described historic data repository, and instructions 124 may acquire predictive information 184 from the historic data repository.

As described above, the predictive function may be a regression function relating the quantitative security vulnerability reporting metrics to the quantitative source code analysis metrics, and predictive information 184 may comprise respective values for a plurality of coefficients of the regression function. The quantitative security vulnerability reporting metrics may be any such metrics described herein, and the quantitative source code analysis metrics may be any such metrics described herein. For example, each of the quantitative security vulnerability reporting metrics may be an exploitable security vulnerability reporting rate for a respective historic release the application, and each of the source code analysis metrics may be an issue density value for a respective one of the historic releases of the application. In such examples, the predictive function may be regression function 143 relating the exploitable security vulnerability reporting rates of column 140E of table 140 of FIG. 1B to the issue density values of column 140D of table 140. In such examples, predictive information 184 may comprise coefficient A value 146 and coefficient B value 148.

In the example of FIG. 1A, estimate engine 126 may determine an estimate 186 of a quantity of exploitable security vulnerabilities contained in the target release of the application based on predictive information 184 and source code analysis result 182 for the target release. For example, engine 126 may determine an output of the predictive function represented by predictive information 184 with a target source code analysis metric based on the source code analysis result as input to the predictive function. This output may be an estimated quantitative security vulnerability reporting metric for the target release, which may be the estimate 186 of the quantity of exploitable security vulnerabilities contained in the target release. As used herein, the “output” of a function with a given value as “input” is a result of the function when the given value is input to the function as the value of a variable of the function. For example, the output of regression function 143 with a given value as input may be the Y value of the function when the given value is input as the X value of the function (or the X value when the given value is input as the Y value).

As described above, in some examples, the quantitative security vulnerability reporting metrics may be exploitable security vulnerability reporting rates for the historic releases (such as the reporting rates of column 140E of table 140) and the quantitative source code analysis metrics may be total issue densities for the historic releases (such as the values of column 140D of table 140). In such examples, estimate engine 126 may determine a predicted exploitable security vulnerability reporting rate for the target release of the application based on source code analysis result 182 and predictive information 184. For example, estimate engine 126 may determine, as the predicted reporting rate, an output of the predictive function with a target source code analysis metric (i.e., total issue density) based on source code analysis result 182 as input. For example, estimate engine 126 may determine a total issue density for the target release based on source code analysis result 182, and determine a reporting rate (i.e., the Y value) produced by regression function 143 with the total issue density for the target release as input to the regression function (i.e., as the X value). As an example, estimate engine 126 may determine a total issue density value for the target release of 2.61, for example, as illustrated in FIG. 1C. In such examples, engine 126 may input the total issue density value 2.61 as the X value in regression function 143 (e.g., Y=0.5811+0.7431*X), and determine the resulting Y value of 2.52 (as illustrated in FIG. 1C) to be an estimated exploitable security vulnerability reporting rate for the target release. For example, engine 126 may determine that Y=0.5811+0.7431*2.61=2.52, and thereby determine that the estimated exploitable security vulnerability reporting rate for the target release is 2.52.

In examples described herein, the reporting rate resulting from regression function 143 may be an estimated exploitable security vulnerability reporting rate for the target release. The estimated exploitable security vulnerability reporting rate for the target release may be an estimate of the quantity of exploitable security vulnerabilities contained in the target release. For example, an estimated exploitable security vulnerability reporting rate for the target release that is high relative to a reporting rate for a historic release may serve as an estimate that the target release includes a relatively high number of exploitable security vulnerabilities. An estimated exploitable security vulnerability reporting rate for the target release that is low relative to a reporting rate for a historic release may serve as an estimate that the target release includes a relatively low number of exploitable security vulnerabilities.

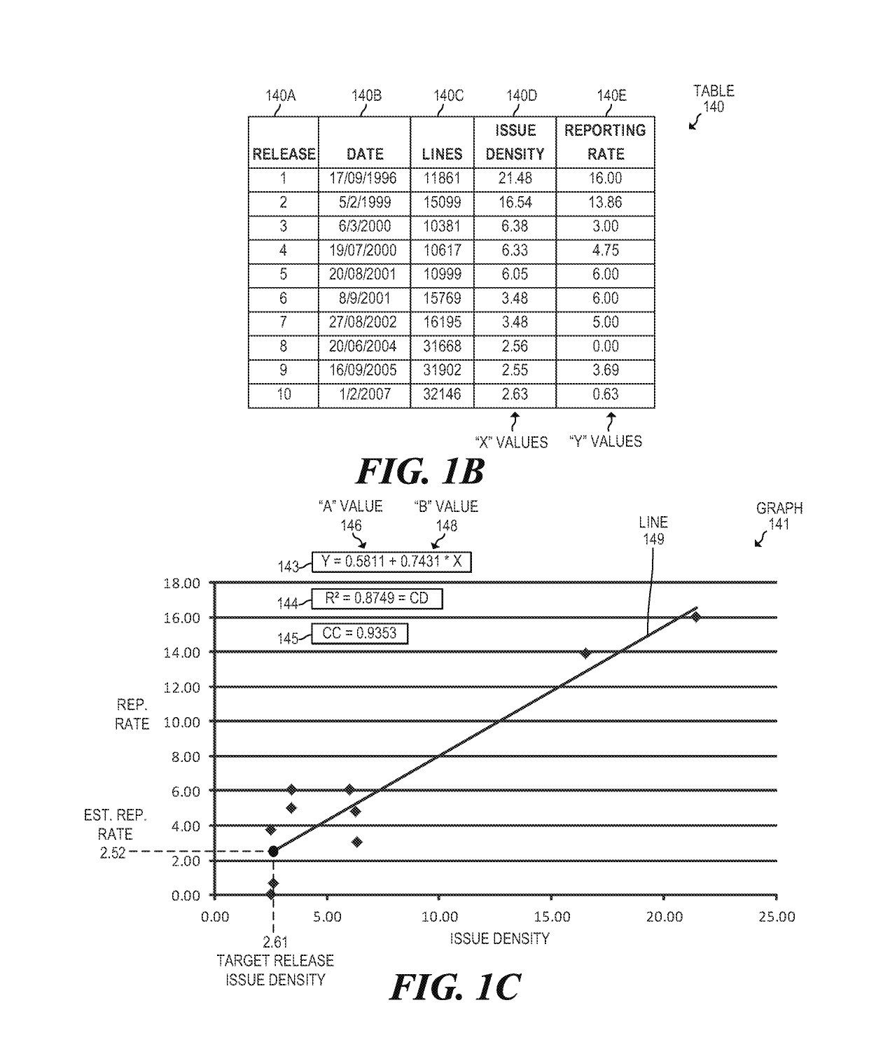

In some examples, the estimated exploitable security vulnerability reporting rate (or other estimate of the quantity of exploitable security vulnerabilities) for the target release may be output to a user of system 100, who may utilize the reporting rate to evaluate the risk of using the target release. For example, if the estimated reporting rate for the target release is high relative to the reporting rates for historic releases, the user may determine that the risk of using the target release is high. Alternatively, if the estimated reporting rate is low relative to that of historic releases, the user may determine that the risk of using the new release is low. In some examples, functionalities described herein in relation to FIGS. 1A-1C may be provided in combination with functionalities described herein in relation to any of FIGS. 2-5.

FIG. 2 is a block diagram of an example system 200 to estimate a quantity of exploitable security vulnerabilities contained in a target release of an application based on information stored in a historic data repository 250. In the example of FIG. 2, system 200 includes engines 122, 124, and 126, described above in relation to FIGS. 1A-1C. In some examples, system 200 may also include a calculation engine 125. System 200 may be implemented by at least one computing device, and may include historic data repository 250, which may be implemented by at least one machine-readable storage medium. In other examples, historic data repository 250 may be separate from system 200.

As described above, source code engine 122 may acquire, from a source code analysis system 115, a source code analysis result 182 representing a number of source code issues identified by source code analysis system 115 in a target release of an application. In the example of FIG. 2, repository 250 may include historic source code analysis results 252 for historic releases of the application predating the target release. Historic source code analysis results 252 may be obtained from system 115 (or any other system that performs source code analysis), and stored in historic data repository 250. In some examples, engine 122 may acquire results 252 from system 115 (or any other suitable system) and store results 252 in repository 250. In other examples, results 252 may be obtained and stored in repository 250 by another system separate from system 200.

In some examples, a system that performs source code analysis, such as system 115, may classify issues identified in analyzed source code based on the criticality of the issues, using categories such as “critical”, “high”, and “low”, or the like. In such examples, the historic source code analysis results 252 may include results for at least one such category. For example, results 252 may include, for each of the historic releases, at least one of a number of critical issues identified, a number of high issues identified, a number of low issues identified, a total number of critical and high issues identified (i.e., “critical-high issues”), and a total number of critical, high, and low issues identified. Each such number may be referred to herein as a different “type” of source code analysis result. In such examples, instructions 122 may acquire a plurality of source code analysis results 182, which may include, for the target release, at least one of a number of critical issues identified, a number of high issues identified, a number of low issues identified, a total number of critical and high issues identified, a total number of critical, high, and low issues identified, and the like.

In some examples, a system that performs source code analysis, such as system 115, may not report all possible issues that it may identify, but rather may report a selected subset of such issues. In such examples, source code analysis results for select types of issues may be utilized in the estimation of a quantity of exploitable security vulnerabilities in a target release, as described herein. For example, the source code analysis system may be configured to report security-related issues, while not reporting other types of issues (e.g., style-checking issues, performance-optimization issues, etc.). In some examples, the source code analysis system may be configured to report issues identified in an application that are related to use of a network (e.g., data received from a network, etc.) while not reporting local issues that do not involve a network. In some examples, the system may receive criteria defining what types of issues to report. In such examples, source code analysis results returned by the system may represent issues identified that meet the specified criteria.

In some examples, calculation engine 125 may determine quantitative source code analysis metrics 236-1-236-K (where “K” is an integer greater than 1) for the historic releases of the application from historic source code analysis results 252. Engine 125 may store the determined quantitative source code analysis metrics 236-1-236-K in repository 250. As used herein, to “determine” a quantitative source code analysis metric is to select a source code analysis result to utilize as a quantitative source code analysis metric or to calculate or otherwise derive a quantitative source code analysis metric based on a source code analysis result.

In some examples, engine 125 may determine at least one of quantitative source code analysis metrics 236-1-236-K for the historic releases by selecting respective type(s) of source code analysis results from among results 252. In some examples, engine 125 may select any type of results among results 252 as a plurality of quantitative source code analysis metrics 236-j (where “j” is an integer between 1 and K, inclusive). For example, engine 125 may select the total issue values (i.e., total critical, high and low issues) for the historic releases as quantitative source code analysis metrics 236-1. As another example, engine 125 may select the respective numbers of critical issues identified for each of the historic releases as quantitative source code analysis metrics 236-2.

In some examples, engine 125 may determine at least one of quantitative source code analysis metrics 236-1-236-K for the historic releases by deriving quantitative source code analysis metrics based on the results 252. In some examples, engine 125 may derive a set of quantitative source code analysis metrics based on any type of results among results 252. For example, engine 125 may derive respective critical issue densities for each of the historic releases as quantitative source code analysis metrics 236-(K−1). In such examples, for each historic release, engine 125 may obtain a respective critical issue density by dividing the total number of critical issues identified for the historic release by the number of lines of source code included in the historic release. As another example, engine 125 may derive respective total issue densities for each of the historic releases as quantitative source code analysis metrics 236-K by, for each historic release, dividing a respective total number of issues for the historic release by a number of lines of source code of the historic release. Other example quantitative source code analysis metrics may include critical-high issue density (e.g., the total number of critical and high issues divided by the number of lines of source code), high issue density (e.g., the number of high issues divided by the number of lines of source code), low issue density, etc.

In the example of FIG. 2, repository 250 may also store vulnerability reporting data 254 describing the exploitable security vulnerabilities reported for each of the historic releases of the application. Repository 250 may also store respective quantitative security vulnerability reporting metrics 256 for the historic releases, which may be derived from data 254 (e.g., by engine 125 or a system separate from system 200). In the example of FIG. 2, the quantitative security vulnerability reporting metrics 256 may be exploitable security vulnerability reporting rates for the historic releases, respectively. In such examples, the reporting rates may be derived from data 254 as described below in relation to FIG. 3.

In the example of FIG. 2, repository 250 may comprise a plurality of predictive functions 234-1-234-K. In such examples, each predictive function 234-j may relate quantitative security vulnerability reporting metrics 256 to an associated plurality of quantitative source code analysis metrics 236-j. In some examples, each predictive function 234-j may include coefficient value(s) 235-j (i.e., values of coefficients of the predictive function). As such, repository 250 may store coefficient values 235-1-235-K. Repository 250 may also comprise a plurality of a correlation values 232-1-232-K, each associated with a respective plurality of quantitative source code analysis metrics 236-j of a different type for the plurality of historic releases of the application. In such examples, each correlation value 236-j indicates a degree of correlation between its associated plurality of quantitative source code analysis metrics 236-j and quantitative security vulnerability reporting metrics 256. For example, each predictive function 234-j may be a linear regression function 243 with respective coefficient values 235-j. For example, coefficient values 235-1 may include a coefficient A value 246 and a coefficient B value 248. In such examples, each correlation value 232-j may be a CC or CD value for the associated predictive function 234-j.

As described above in relation to FIGS. 1A-1C, acquisition engine 124 may acquire predictive information 184 at least partially representing a predictive function 234-j relating the plurality of quantitative security vulnerability reporting metrics 256 for the historic releases of the application predating the target release to a plurality of quantitative source code analysis metrics 236-j for the historic releases. In the example of FIG. 2, predictive information 184 may be stored in repository 250, and engine 124 may acquire predictive information 184 from historic data repository 250. In some examples, the predictive information 184 may be a predictive function 234-j, coefficient value(s) 235-j of the predictive function 234-j, or any other information at least partially representing predictive function 234-j.

In some examples, engine 124 may acquire predictive information 184 at least partially representing a predictive function 234-j associated with a greatest correlation value 232-j among the plurality of correlation values 232-1-232-K. In such examples, engine 124 may access correlation values 232-1-232-K in repository 250 and determine a greatest correlation value 232-j among correlation values 232-1-232-K (e.g., a correlation value 232-j for which there is no greater correlation value among 232-1-232-K, though a correlation value of equal value may exist). In such examples, engine 124 may retrieve predictive information 184 at least partially representing the predictive function 234-j associated with the determined greatest correlation value 232-j. In such examples, predictive information 184 may include predictive function 234-j, coefficient value(s) 235-j, or any other information at least partially representing predictive function 234-j.

In the example of FIG. 2, estimate engine 126 may determine an estimate 186 of a quantity of exploitable security vulnerabilities contained in the target release of the application based on predictive information 184 and source code analysis result(s) 182 for the target release, as described above in relation to FIGS. 1A-1C. In examples in which engine 124 acquires predictive information 184 representing a predictive function associated with a greatest correlation value 232-j, estimate engine 126 may determine estimate 186 based on the quantitative source code analysis metrics 236-j that show a strongest correlation with quantitative security vulnerability reporting metrics 256 (e.g., by using predictive function 234-j). In this manner, system 200 may produce a more reliable estimate 186.

Although the data contained by historic data repository 250 is described above as being acquired or determined by engines 122 and 125 and stored in repository 250 by engines 122 and 125, in other examples, the data may be acquired or determined and stored in repository 250 by system(s) separate from system 200. In some examples, functionalities described herein in relation to FIG. 2 may be provided in combination with functionalities described herein in relation to any of FIGS. 1A-1C and 3-5.

FIG. 3 is a block diagram of an example computing device 300 to estimate a quantity of exploitable security vulnerabilities contained in a target release of an application based on source code analysis results and security vulnerability reporting metrics. In the example of FIG. 3, computing device 300 includes a processing resource 310 and a machine-readable storage medium 320 comprising (e.g., encoded with) instructions 321-327. In some examples, storage medium 320 may include additional instructions. In other examples, instructions 321-327, and any other instructions described herein in relation to storage medium 320, may be stored on a machine-readable storage medium remote from but accessible to computing device 300 and processing resource 310. Processing resource 310 may fetch, decode, and execute instructions stored on storage medium 320 to implement the functionalities described below. In other examples, the functionalities of any of the instructions of storage medium 320 may be implemented in the form of electronic circuitry, in the form of executable instructions encoded on a machine-readable storage medium, or a combination thereof. Machine-readable storage medium 320 may be a non-transitory machine-readable storage medium.

In the example of FIG. 3, instructions 321 may acquire source code analysis result(s) 382, each representing a number of source code issues identified by source code analysis performed on a target release 307 of an application. Source code analysis result(s) 382 may include at least one of any type of source code analysis result described above in relation to FIG. 2. Instructions 321 may acquire results 382 from source code analysis system 115, as described above in relation to FIG. 1A. Instructions 321 may request results 382 from system 115 and provide system 115 with that system 115 may use to access target release 307 (e.g., source code of target release 307). In other examples, instructions 321 may provide the source code of target release 307 to system 115. In other examples, a user or other system may acquire result(s) 382 from a source code analysis system and subsequently input result(s) 382 to computing device 300 as part of target release information 390, which may be received by instructions 321.

Instructions 322 may acquire a plurality of second source code analysis results 384, each representing a number of source code issues identified by source code analysis performed on a respective one of a plurality of historic releases 305 of the application predating the target release. Source code analysis results 384 may include, for each of historic releases 305, any type of source code analysis results described above in relation to FIG. 2. In other examples, results 384 may include multiple of the above-described types of source code analysis results for each of historic releases 305. In other examples, a user or other system may acquire results 384 from a source code analysis system and subsequently input results 384 to computing device 300 as part of historic release information 392, which may be received by instructions 322.

Instructions 323 may determine quantitative source code analysis metrics 336 based on second source code analysis results 384, in any manner described above in relation to FIG. 2. Instructions 323 may also determine a target quantitative source code analysis metric 383 based on a first source code analysis result 382, in any manner described above in relation to FIG. 2. In some examples, instructions 323 may determine metric(s) 383 of the same type as at least one set of metrics 336. For example, when instructions 323 determine metrics 336 including total issue density metrics for historic releases 305, instructions 323 may also determine a total issue density for target release 307.

Instructions 324 may acquire reporting data 394, which may include information associated with exploitable security vulnerabilities reported for the historic releases 305. In some examples, reporting data 394 may indicate, for each of historic releases 305, the number of exploitable security vulnerabilities reported, information describing details of each vulnerability reported, and the like, or any combination thereof. Instructions 324 may acquire reporting data 394 from any suitable source of such data, such as at least one database, user input, or the like.

Instructions 324 may further determine a plurality of quantitative security vulnerability reporting metrics 356, each representing a quantity of exploitable security vulnerabilities reported for a respective one of historic releases 305 of the application. In some examples, quantitative security vulnerability reporting metrics 356 may comprise respective exploitable security vulnerability reporting rates (VRRs) for historic releases 305. For example, for each of historic release 305, instructions 324 may determine an exploitable security vulnerability reporting rate (VRR), which, as described above, may be a measure of the number of exploitable security vulnerabilities reported per year (or any other length of time).

In some examples, to calculate the VRR for a given historic release of the application, instructions 324 may determine the number of exploitable security vulnerabilities (ESVs) reported between the release date of the given historic release and the release date of the next release analyzed (e.g., the next one of the historic releases or the target release), and divide that number by the time interval between the release dates of the releases (which may include fractions of years, as releases may not be released on January 1st). As an example, if a historic release rₙ was released on day dₙ of year y1, and the next release analyzed (e.g., the next historic release or the target release) was released on day dₙ₊₁ of year y2 (i.e., the year after y1), then instructions 324 may calculate the VRR for historic release rₙ according to the following Equation 1:

$$VRR = \frac{{esv}_{y 1} * ( 365 - {d}_{n} ) + {esv}_{y 2} * {d}_{n + 1}}{365 - {d}_{n} + {d}_{n + 1}}$$

In Equation 1, esv_{y1} and esv_{y2} represent the number of exploitable security vulnerabilities reported for historic release rₙ in years y1 and y2, respectively.

For a release interval spanning m consecutive years y1-ym, where m>2, instructions 324 may calculate VRR for historic release rₙ according to the following Equation 2:

$$VRR = \frac{{esv}_{y 1} * ( 365 - {d}_{n} ) + {esv}_{ym} * {d}_{n + 1} + 365 * {\sum }_{i = 1}^{m - 1} {esv}_{yi}}{365 - {d}_{n} + {d}_{n + 1} + ( m - 2 ) * 365}$$

In Equation 2, esv_{yi} is the number of exploitable security vulnerabilities reported for historic release rₙ in year yi (of years y1-ym). In such examples, if releases and rₙ₊₁ were released in the same year, then instructions 324 may calculate VRR for historic release rₙ according to the following Equation 3 (in which esv_{y1} is defined as described above):

$$VRR = \frac{{esv}_{y 1} * ( {d}_{n + 1} - {d}_{n} )}{{d}_{n + 1} - {d}_{n}}$$

In other examples, VRR for a given one of historic releases 305 may be calculated in any other suitable manner.

In some examples, instructions 324 may also receive a selection of filtering criteria 396. In such examples, the selection of filtering criteria 396 may be received via user input, for example, or in any other suitable manner. In such examples, instructions 324 may determine, based on the selected filtering criteria 396, a subset of the collection of vulnerability reporting data 394 for the historic releases of the application, and determine the quantitative security vulnerability reporting metrics 336 based on the subset of the collection of vulnerability reporting data 394. The selected filtering criteria 396 may indicate data to exclude from reporting data 394 when calculating quantitative security vulnerability reporting metrics 336. For example, selected filtering criteria 396 may indicate to exclude reports of exploitable security vulnerabilities in a historic release where the problem(s) detailed by the reports are external to the historic release itself. For example, based on selected filtering criteria 396, instructions 324 may exclude reports indicating that the reported problem was due to incorrect use of application programming interface(s) (APIs) by third-party application(s), bug(s) in third-party application(s) or plug-in(s), and the like. In such examples, instructions may calculate quantitative security vulnerability reporting metrics 336 (e.g., VRRs for each of historic releases 305) based on a subset of reporting data 394 excluding the data specified by the selected filtering criteria 396.

In the example of FIG. 3, instructions 325 may determine a predictive function 385 relating quantitative security vulnerability reporting metrics 356 to the quantitative source code analysis metrics 336 based on the second source code analysis results 384. Instructions 325 may determine predictive function 385 in any manner described above. For example, the predictive function may be a linear or non-linear regression function relating quantitative security vulnerability reporting metrics 356 to the quantitative source code analysis metrics 336. Instructions 325 may also determine at least one of the CC and CO for metrics 356 and 336, as described above in relation to FIGS. 1A-1C. In other examples, instructions 325 may determine a plurality of different predictive functions, each relating metrics 356 to a different set of metrics 336, as described above in relation to FIG. 2. In such examples, instructions 325 may also determine at least one of the CC and CD associated with each predictive function, and select (as predictive function 385) the predictive function having the greatest strength of correlation based on at least one of CC and CD.

In some examples, instructions 326 may store historic data 388 in a historic data repository 350. Historic data repository 350 may be implemented by at least one machine-readable storage medium and may be included in or separate from computing device 300. Instructions 326 may store at least one of the plurality of second source code analysis results 384 and the quantitative source code analysis metrics 336 in repository 350 as part of historic data 388. Instructions 326 may also store at least one of the plurality of quantitative security vulnerability reporting metrics 356 and the collection of vulnerability reporting data 394 for historic releases 305 of the application in repository 350 as part of historic data 388. In some examples, instructions 326 may also store in repository 350 at least one of the predictive functions. CC values, and CD values determined by instructions 325 based on historic data 388. In some examples, computing device 300 may fill repository 350 with data such that it may subsequently be utilized as described above in relation to repository 250 of FIG. 2.

In the example of FIG. 3, instructions 327 may calculate, as an estimate 397 of a quantity of exploitable security vulnerabilities contained in the target release of the application, an output of predictive function 385 with a value based on one of first source code analysis result(s) 382 as input to predictive function 385. For example, instructions 327 may calculate the output of predictive function 385 with target quantitative source code analysis metric 383 as the input to predictive function 385.

In examples in which predictive function 385 relates a particular type of quantitative security vulnerability reporting metrics for historic releases 305 to a given type of quantitative source code analysis metrics for historic releases 305, the input to the predictive function 385 may be a quantitative source code analysis metric of the given type for the target release, and the output may be an estimated quantitative security vulnerability reporting metric of the particular type for target release 307. For example, predictive function 385 may relate VRRs for historic releases 305 to total issue densities for historic releases 305. In such examples, instructions 327 may calculate an estimated VRR for target release 307 as the estimate 397 by determining an output of predictive function 385 (i.e., the VRR for target release 307) with a total input density (i.e., the target quantitative source code analysis metric 383) as input to predictive function 383.

In examples described herein, an estimated VRR for a target release 307 of the application, based on a predictive function relating VRRs for historic releases to quantitative source code analysis metrics for the historic releases, may be a reliable estimate of the quantity of exploitable security vulnerabilities in target release 307, as a statistically significant correlation has been shown between VRR and several quantitative source code analysis metrics. For example, correlation calculations for a total of 75 sample releases (including several releases of each of a plurality of different applications) indicate a moderate correlation between certain normalized quantitative source code analysis metrics and normalized VRRs. The correlation calculations for such “normalized” values indicate whether a change in a metric value between releases for a given application can explain a corresponding change in VRR between releases for the given application. The correlation calculations for the 75 sample releases indicate a moderate correlation for several normalized quantitative source code analysis metrics, including the total number of issues identified, total issue density, and critical-high issue density. Each of these correlations is significant at the 99% level and explains over 30% of the variance in VRR for the releases. As such, a large increase in total issue density, for example, for a target release (compared to a historic release) is indicative of an estimated increase in VRR in the target release relative to the historic release.

In some examples, instructions 327 may output a report 399 indicating the estimate 397 and at least one estimate 398 of a strength of a correlation between the plurality of quantitative security vulnerability reporting metrics 356 (e.g., VRRs) for the historic releases 305 and source code analysis metrics 336 for historic releases 305. In some examples, the estimate 398 of the strength of the correlation may be, for example, at least one of a CC and a CD determined for the predictive function 385, as described above. In some examples, report 399 may be output on a display 340 (e.g., a monitor, screen, touch screen, etc.) of or otherwise connected to computing device 300. In other examples, report 399 may be output in any other suitable manner. In some examples, functionalities described herein in relation to FIG. 3 may be provided in combination with functionalities described herein in relation to any of FIGS. 1A-2 and 4-5.

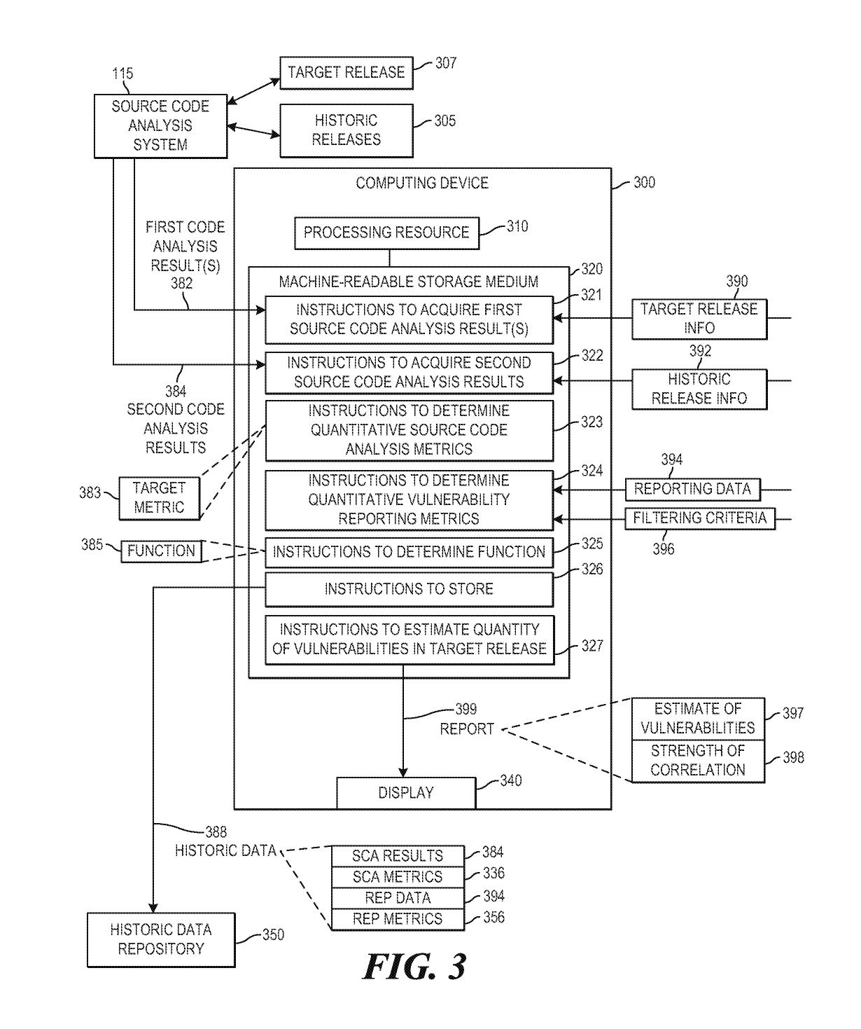

FIG. 4 is a flowchart of an example method 400 for estimating a quantity of exploitable security vulnerabilities contained in a target release of an application based on a source code analysis result and predictive information. Although execution of method 400 is described below with reference to computing device 300 of FIG. 3, other suitable systems for execution of method 400 can be utilized (e.g., system 100 or 200). Additionally, implementation of method 400 is not limited to such examples.

At 405 of method 400, processing resource 310 may execute instructions 325 to determine a predictive function 385 relating a plurality of exploitable security vulnerability reporting rates (i.e., metrics 356) for a plurality of historic releases 305 of an application to a plurality of quantitative source code analysis metrics 336 for historic releases 305. At 410, processing resource 310 may execute instructions 321 to acquire, from source code analysis system 115, a source code analysis result 382 representing a number of source code issues identified by the system 115 for a target release 307 of the application, where the target release 307 follows the historic releases 305 (i.e., has a release date after the release dates of historic releases 305).

At 415, processing resource 310 may execute instructions 327 to input a value based on source code analysis result 382 to predictive function 385 to obtain an estimate 397 of a quantity of exploitable security vulnerabilities contained in the target release 305 of the application. For example, instructions 327 may input a target quantitative source code analysis metric 383 (e.g., total issue density, etc.) based on result 382 to predictive function 385. The target quantitative source code analysis metric 383 may be the same type of metric as the quantitative source code analysis metrics 336 for historic releases 305.

At 420, processing resource 310 may execute instructions 327 to output a report 399 indicating the estimate 397 (e.g., an estimated exploitable security vulnerability reporting rate for target release 305) and at least one estimate 398 of a strength of a correlation between the plurality of exploitable security vulnerability reporting rates and the source code analysis metrics 336. In some examples, functionalities described herein in relation to FIG. 4 may be provided in combination with functionalities described herein in relation to any of FIGS. 1A-3 and 5.

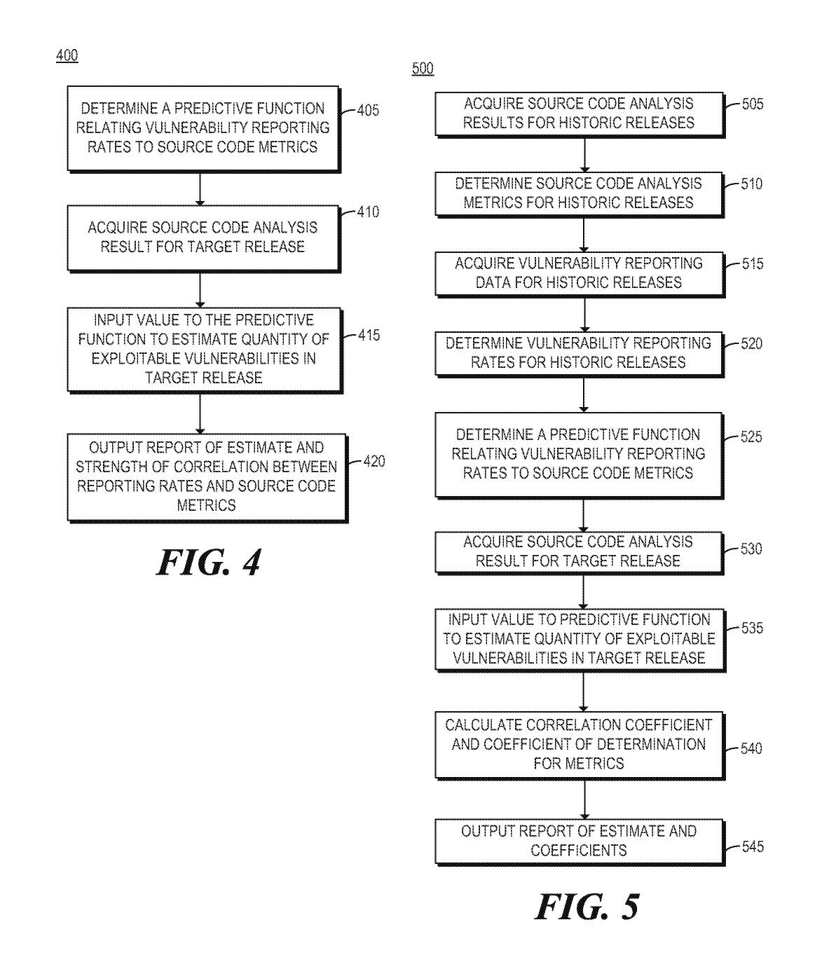

FIG. 5 is a flowchart of an example method 500 for calculating an estimate of the strength of a correlation between security vulnerability reporting metrics and source code analysis metrics. Although execution of method 500 is described below with reference to computing device 300 of FIG. 3, other suitable systems for execution of method 500 can be utilized (e.g., system 100 or 200). Additionally, implementation of method 500 is not limited to such examples.

At 505 of method 500, processing resource 310 may execute instructions 322 to acquire, from a source code analysis system 115, a plurality of historic source code analysis results 384 for a plurality of historic releases 305 of an application, respectively. At 510, processing resource 310 may execute instructions 323 to determine source code analysis metrics 336 for historic releases 305 based on historic source code analysis results 384. At 515, processing resource 310 may execute instructions 324 to acquire vulnerability reporting data 394 for the historic releases 305. At 520, processing resource 310 may execute instructions 324 to determine a plurality of exploitable security vulnerability reporting rates (VRRs) based on the security vulnerability reporting data 394.

At 525, processing resource 310 may execute instructions 325 to determine a predictive function 385 relating the exploitable security vulnerability reporting rates (VRRs) (i.e., metrics 356) for historic releases 305 to the quantitative source code analysis metrics 336 for historic releases 305. At 530, processing resource 310 may execute instructions 321 to acquire, from source code analysis system 115, a source code analysis result 382 representing a number of source code issues identified by the system 115 for a target release 307 of the application following the historic releases 305.

At 535, processing resource 310 may execute instructions 327 to input a value based on source code analysis result 382 (e.g., a target quantitative source code analysis metric 383 such as a total issue density based on result 382) to predictive function 385 to obtain an estimate 397 of a quantity of exploitable security vulnerabilities contained in the target release 305 of the application. At 540, processing resource 310 may execute instructions 327 to calculate a correlation coefficient (CC) and a coefficient of determination (CD) based on the quantitative source code analysis metrics 336 and the plurality of exploitable security vulnerability reporting rates (VRRs), as described above in relation to FIGS. 1A-1C, for example.

At 545, processing resource 310 may execute instructions 327 to output a report 399 indicating the estimate 397 (e.g., an estimated exploitable security vulnerability reporting rate for target release 305) and at least one estimate 398 of a strength of a correlation between the plurality of exploitable security vulnerability reporting rates and the source code analysis metrics 336. In some examples, the at least one estimate 398 of the strength of the correlation may comprise at least one of the correlation coefficient (CC) and the coefficient of determination (CD) determined at 540. In some examples, functionalities described herein in relation to FIG. 5 may be provided in combination with functionalities described herein in relation to any of FIGS. 1A-4.

What is claimed is:

1. A system comprising:
a source code engine to acquire, from a source code analysis system, a source code analysis result representing a number of source code issues identified by the source code analysis system in a target release of an application;
an acquisition engine to acquire predictive information at least partially representing a predictive function relating a plurality of quantitative security vulnerability reporting metrics for a plurality of historic releases of the application predating the target release to a plurality of quantitative source code analysis metrics for the historic releases of the application; and
an estimate engine to determine an estimate of a quantity of exploitable security vulnerabilities contained in the target release of the application based on the source code analysis result and the predictive information.

2. The system of claim 1, wherein:
each of the quantitative security vulnerability reporting metrics is an exploitable security vulnerability reporting rate for a respective historic release of the plurality of historic releases of the application; and
the estimate engine is to determine a predicted exploitable security vulnerability reporting rate for the target release of the application based on the source code analysis result and the predictive information.

3. The system of claim 2, wherein:
the predictive function is a regression function relating the exploitable security vulnerability reporting rates to the quantitative source code analysis metrics; and
the estimate engine is to determine, as the predicted reporting rate, an output of the regression function with a target source code analysis metric based on the source code analysis result as input to the regression function.

4. The system of claim 3, wherein:
the predictive information comprises a plurality of coefficients of the regression function; and
each of the source code analysis metrics is an issue density value for a respective one of the historic releases of the application.

5. The system of claim 1, further comprising:
a historic data repository storing the source code analysis metrics, the quantitative security vulnerability reporting metrics, and the predictive information; and
wherein the acquisition engine is to acquire the predictive information from the historic data repository.

6. The system of claim 5, wherein:
the repository comprises a plurality of a correlation values each associated with a respective plurality of quantitative source code analysis metrics of a different type for the plurality of historic releases of the application;
each of the correlation values indicates a degree of correlation between its associated plurality of source code analysis metrics and the quantitative security vulnerability reporting metrics; and
the acquisition engine is to acquire, as the predictive information, information at least partially representing a regression function relating the quantitative security vulnerability reporting metrics to the plurality of source code analysis metrics associated with a greatest correlation value among the plurality of correlation values, wherein the regression function is the predictive function.

7. A non-transitory machine-readable storage medium comprising instructions executable by a processing resource to:
acquire a first source code analysis result representing a number of source code issues identified by source code analysis performed on a target release of an application;
acquire a plurality of second source code analysis results, each representing a number of source code issues identified by source code analysis performed on a respective one of a plurality of historic releases of the application predating the target release;
determine a plurality of quantitative security vulnerability reporting metrics, each representing a quantity of exploitable security vulnerabilities reported for a respective one of the historic releases of the application;
determine a regression function relating the quantitative security vulnerability reporting metrics to the quantitative source code analysis metrics based on the second source code analysis results; and
calculate, as an estimate of a quantity of exploitable security vulnerabilities contained in the target release of the application, an output of the regression function with a value based on the first source code analysis result as input to the regression function.

8. The storage medium of claim 7, wherein:
the quantitative security vulnerability reporting metrics comprise exploitable security vulnerability reporting rates for the historic releases of the application, respectively; and
the instructions to calculate comprise instructions to calculate, as an estimated exploitable security vulnerability reporting rate for the target release of the application, an output of the regression function with the value based on the first source code analysis result as the input.

9. The storage medium of claim 8, further comprising instructions to:
determine the quantitative source code analysis metrics based on the second source code analysis results; and
determine a target quantitative source code analysis metric based on the first source code analysis result;
wherein the instructions to calculate comprise instructions to calculate the output of the regression function with the target quantitative source code analysis metric as the input.

10. The storage medium of claim 9, further comprising instructions to:
store, in a historic data repository, at least one of the plurality of second source code analysis results and the quantitative source code analysis metrics, and at least one of the plurality of quantitative security vulnerability reporting metrics and a collection of vulnerability reporting data for the historic releases of the application;
wherein the instructions to acquire the second source code analysis results comprise instructions to acquire the second source code analysis results from a source code analysis system.

11. The storage medium of claim 7, wherein the instructions to determine the quantitative security vulnerability reporting metrics comprise instructions to:
receive a selection of filtering criteria;
determine, based on the selected filtering criteria, a subset of a collection of vulnerability reporting data for the historic releases of the application; and
determine the quantitative security vulnerability reporting metrics based on the subset of the collection of vulnerability reporting data.

12. A method comprising:
determining, with a processing resource of a computing device, a predictive function relating a plurality of exploitable security vulnerability reporting rates for a plurality of historic releases of an application to a plurality of quantitative source code analysis metrics for the historic releases of the application;
acquiring, from a source code analysis system, a source code analysis result representing a number of source code issues identified by the source code analysis system for a target release of an application following the historic releases;
inputting a value based on the source code analysis result to the predictive function to obtain an estimate of a quantity of exploitable security vulnerabilities contained in the target release of the application; and
outputting a report indicating the estimate and at least one estimate of a strength of a correlation between the plurality of exploitable security vulnerability reporting rates and the source code analysis metrics.

13. The method of claim 12, further comprising:
acquiring, from the source code analysis system, a plurality of historic source code analysis results for the historic releases of the application, respectively;
determining the source code analysis metrics based on the historic source code analysis results.

14. The method of claim 13, further comprising:
acquiring vulnerability reporting data for the historic releases of the application; and
determining the plurality of exploitable security vulnerability reporting rates based on the security vulnerability reporting data.

15. The method of claim 14, further comprising:
calculating a correlation coefficient and a coefficient of determination based on the quantitative source code analysis metrics and the plurality of exploitable security vulnerability reporting rates, wherein the at least one estimate of the strength of the correlation comprises the correlation coefficient and the coefficient of determination.
